(19) United States
(12) Patent Application Publication
(10) Pub. No.: US 2002/0159398 A1
(43) Pub. Date: Oct. 31, 2002

(54) Spanning tree control unit in the case of trouble or increase and method thereof

(76) Inventors: Masataka Yamada, Osaka (JP); Yuji Kuwabara, Osaka (JP); Takumi Iwatsuki, Osaka (JP); Takashi Mochizuki, Osaka (JP); Makoto Watanabe, Osaka (JP); Hiroomi Shinha, Osaka (JP); Toshihiro Ikeda, Kawasaki (JP)

Correspondence Address: KATTEN MUCHIN ZAVIS ROSENMAN, 575 MADISON AVENUE, NEW YORK, NY, 10022-2585, US

(21) Appl. No.: 09/972,669

(22) Filed: Oct. 5, 2001

(30) Foreign Application Priority Data
Apr. 27, 2001 (JP) 2001-132578

(51) Int. Cl. H04L 12/28

(52) U.S. Cl. 370/256; 709/221

(57) ABSTRACT

The present invention relates to a method and device for connecting segments of a LAN with each other. Especially, the present invention provides a method and device in which the reconstruction of a network is unnecessary and the operation of the network can be maintained in the case of increase the number of apparatus or trouble of the device in which the spanning tree protocol is used. A method of increasing the number of devices in a network by the protocol or a method of resuming the operation of the device in the network comprises the steps of: making the device transit to a state in which only receiving is conducted in the case of increasing or resuming of the operation; collecting information in the network in a state in which only receiving is conducted; calculating the priority of an own device, by which the existing network topology is not changed, by the collected information; and making the device transit to a sending and receiving possible state after the calculated priority has been set in the own device.

### BACKGROUND OF THE INVENTION

1. Field of the Invention

The present invention relates to an apparatus to connect segments of a LAN together. More particularly, the present invention relates to a method of constructing a network in the case of trouble in an apparatus or increase the number of apparatus to connect equipment, such as a router, a bridge and a switching hub, with each other. Also, the present invention relates to a control unit thereof.

2. Description of the Related Art

In the case where trouble occurs in an apparatus to connect segments of a LAN together, it becomes impossible to conduct communication between the segments. In order to solve the above serious problem, it is common for a network to be composed in such a manner that a plurality of routes are arranged in the network so as to provide a wide selection of routes. Therefore, even if one apparatus fails, the network can be operated through another apparatus connected by another route.

In this case, the following problems may be encountered. Since the network route is a loop, when a broadcast frame is sent, a broadcast storm, which is an infinite increase in the number of frames, is caused, and the network fails, in the worst case. There is provided a “Spanning Tree Protocol” which is a means for preventing the above problem and realizing an enhancement in reliability.

The spanning Tree Protocol is a standard protocol defined by the IEEE802.1D (Routing system: Spanning Tree Standard). The spanning Tree Protocol is a technique of reconstructing a network so that a loop can not be logically formed even if a physical network forms a loop. In the case of an apparatus complying with the above standard protocol, when a BPDU (Bridge Protocol Data Unit) is exchanged between the adjoining bridges in a plurality of bridges, it becomes possible to prevent the generation of a logical loop in a network. Therefore, even in the case of the occurrence of trouble in a communication route, it becomes possible to dynamically arrange a detour route having no loop.

FIG. 1 is a view showing an example of a physical network constructed by a spanning tree protocol. FIG. 2 is a view showing a logical network of FIG. 1.

In FIG. 1, bridge (BR-1) 13 is a root bridge and it is connected with all other bridges (BR-2 to BR-6) 10 to 12, 14 and 15, and each of bridges 10 to 15 connects the adjoining LANs with each other.

At this time, consideration is given to a case in which a frame is sent from the terminal 21 in LAN (B) to the terminal 22 in LAN (C). In this case, two physical routes exist. One is the first route of terminal 21→LAN(B)→BR-3 LAN(A)→BR-2→LAN(C)→terminal 22, and this first route is shown by a solid line. The other is the second route of terminal 21 LAN(B)→BR-4→LAN(D)→BR-1→LAN(C)→terminal 22, and this second route is shown by a dotted line.

In this case, a loop route exists which connects bridges (BR-1 to BR-4) 10 to 13 with each other. However, when the spanning tree protocol is executed, one port of bridge (BR-4) 12 is set to be a blocking port (BL). As a result, communication to this port is shut off, so that the above loop ceases to exist. That is, only the first route becomes an effective communication route between the terminal 21 and the terminal 22.

FIG. 2 is a view showing a logical connection structure of the network after the execution of the spanning tree protocol. In FIG. 2, a tree-shaped network, the trunk of which is the route bridge 13, is constructed. In this case, in addition to the above bridge 12, one port of the bridge 14 is set to be a blocking port. Therefore, a loop between the bridge 14 and the bridge 15 is shut off.

FIG. 3 is a view showing a BPDU message format.

As shown in FIG. 3, a BPDU message is transmitted as an Ethernet frame signal (IEEE802.3). For DA, in which (6) shows 6 bytes of the header portion, a special multi-cast address “01-80-C2-00-00-00”, which is determined as a bridge group address, is constantly used. For SA(6), the transmitter MAC address of the bridge itself is set. For, DSAP(1) and SSAP(1), a value (01000010), which is determined as STP, is used.

For BPDU message of the data field, two types of messages are used. One is a configuration BPDU message for reconstructing the network by using Spanning Tree Protocol. The other is a topology change notification BPDU for notifying a network topology. These are distinguished by the BPDU message type. In this case, the former is “0”, and the latter is “128 (decimal number)”.

A configuration BPDU message is used when a topology is constructed or when a hello packet is periodically sent to the adjoining bridge. Also, a configuration BPDU message is used when the route bridge 13 notifies a change in topology to other bridges 10 to 12, 14 and 15. On the other hand, a topology change notification BPDU message is used when a bridge other than the route bridge detects a topology change. In the case of detecting a topology change, the detected topology change is transmitted to the route port (RO), and the bridge, which has received the topology change, also transmits it to the route port. Due to the foregoing, the route bridge 13 detects the topology change.

A TC (Topology Change) flag (1 bit) is a flag to notify the generation of a topology change. In the case where this flag in the BPDU message received from the route port (RO) is “1”, the bridge on the receiving side does not use a long cash time which is usually used but uses a transmission delay time. The transmission delay time (2) shows the time from a blockade state to a transmission state in the case where a topology change is caused. This transmission delay time (2) is notified from the route bridge 13 to other bridges 10 to 12, 14 and 15.

A TCA (Topology Change Acknowledge) flag (1 bit) is used as a response to the above topology change notification BPDU message. In the case where this flag in the BPDU message received from the route port (RO) is “1”, a low-ranking bridge (child), which has received this BPDU message, knows that it is unnecessary to inform the topology change to the high-ranking bridge. In this case, the high-ranking bridge transmits the topology change to the route bridge 13.

Route ID (8) is composed of the priority of the two high-ranking octets and the ID of the low-ranking octet. Route ID (8) is the bridge ID of the bridge 13 which recognizes that the bridge which sends the BPDU message is a route bridge. The route path cost (4) is a total of the path cost by which the BPDU sending message is sent from the route bridge to the receiving port. Bridge ID (8) is composed of the ID of 6 octets of each bridge and the priority of 2 octets. A port ID (2) is a port ID of a BPDU sending port of each bridge. The port ID (2) is composed of the priority of 1 octet and the port number allotted to the bridge.

The message age (2) is set at “0” when the route bridge 13 periodically sends the hello packet. The message age (2) is sent, as it is, as “0” when other bridges 11, 12, 14 and 15, which have received the BPDU message from the route bridge 13, transmit to the next bridge 10. On the other hand, when each bridge voluntarily sends the BPDU message although it has not received the hello packet from the high-ranking bridge, the passing time is set after the latest BPDU message has been received from the route bridge 13.

The maximum age (2) shows a time-out value of the aforementioned message age and is informed from the route bridge 13 to other bridges 10 to 12, 14 and 15. The hello interval (2) is an interval at which the route bridge 13 sends the BPDU message. In the same manner as described before, the hello interval (2) is notified from the route bridge to other bridges.

FIG. 4 is a state transition diagram of a spanning tree. In FIG. 4, first, by the initialization of bridge management, it transits from a disable state in which the spanning tree protocol does not act to an enabled state in which the port can be used and the spanning tree protocol can act (1). At the beginning, it becomes the transmission stopping state (blocking state). Next, when the aforementioned port is selected as a route port or representative port by the algorithm of the spanning tree protocol, it transits to the sending and receiving stopping state (listening state) (3).

In the above listening state, network information is collected through the aforementioned route port and the representative port. After a predetermined period of time (bridge-forward-delay timer) has passed, it transits to the topology learning state (learning state) (5). After a position in the topology with respect to the self bridge has been confirmed by this learning and the necessary setting has been conducted, it transits to the transmission permitting state (forwarding state) after the predetermined period of time (bridge-forward-delay timer) has passed in the same manner as that described above (5). Due to the foregoing, operation as a bridge is started.

In the above blocking state, listening state and forwarding state, when the selection is made by the algorithm of the spanning tree protocol as a port except for a route port or representative port, that is, when the selection is made as a blocking port, it transits from each state to the blocking state (4). Further, for the reason of management or trouble, it transits to the stopping state (disable state) (2). According to the above sequence, each device determines the situation of the self-device in the network between the adjoining devices and also determines the state of the port and, as a result, the network of the logical tree structure is composed. In this connection, the aforementioned state transition is executed for each port in the bridge.

FIG. 5 is a view showing an example of the network constructed by the spanning tree protocol.

As shown in FIG. 5, the network of this tree structure is determined by the bridge priority, which has been set for each device, and the port priority which has been set for the port of each device.

In the initial stage, on the assumption that each bridge itself is a route bridge, route ID (bridge priority) shown in FIG. 3, its own bridge ID (bridge priority), port ID (port priority) and configuration BPDU message, in which the route path cost=0 is set, are sent from all ports except for the ports in the stopping state (disable state) in FIG. 4 to the opposed ports of the adjoining other bridges. After that, it transits from the transmission stopping state (blocking state) to the sending and receiving stopping state (listening state). The device having the lowest setting value in the network becomes the route bridge 31 via the topology learning state, and other devices 32 to 35 are positioned under the command of the route bridge 21.

More specific explanations will be made as follows. Pieces of information such as route ID, bridge ID, port ID and route path cost are exchanged between the adjoining bridges by the configuration BPDU message. Each bridge receiving the configuration BPDU message compares it with the content the bridge has sent, and judges which is the most appropriate. After the renewal processing has been conducted on the necessary information, the bridges 31 having the smallest route IDs (42) in the designated network are finally determined to be the route bridges.

Next, a distance from each bridge to the route bridge is calculated. This is determined by the path cost in the BPDU message which is sent from the adjoining bridge. One port, the path cost to the route bridge 31 of which is lowest in all the ports in the bridges, is selected as a route port (RO). In this connection, the route bridge 31 has not route port (RO).

All ports included in the spanning tree except for the route port (RO) are selected to be representative ports. A representative port is a port to transmit the BPDU message, which is sent from the route bridge 31, to the bridges under its command. On the other hand, ports not included in the spanning tree except for the route port and representative port are set as blocking ports (BL) as shown in 4 in FIG. 4, and all frame transmission which passes via the blocking ports is shut off.

According to the aforementioned spanning tree protocol, while the tree structure in the network is being determined, each device acts according to the transition state diagram of FIG. 4. In order to transit to the forwarding state in which sending and receiving of data are started, communication between the networks is stopped in a period of time of the delay timer (Bridge-forward-delay timer; it is defined to be 4 to 30 seconds in IEEE802.1D)×2.

That is, the following problems may be encountered. In the bridged network on which the spanning tree protocol is mounted, even if a plurality of communication paths between the networks are prepared so as to enhance the resistance to faults, communication is interrupted in a period of time in which the network topology is reconstructed. Typical two examples of changing the network structure are shown as follows.

FIGS. 6A, 6B and 7 are views showing an example of the network reconstruction caused in the case of a bridge faults or bridge removal.

FIG. 6A is a view showing an example of the simplest lengthy connection in which network A and network B are connected with each other by the bridges 43 and 44. In this case, when the spanning tree protocol is executed, the bridge 43 becomes a route bridge, and the bridge 44 becomes a low-ranking bridge of the route bridge. As a result, one port of the bridge 44 becomes a route port (RO), and the other port of the bridge 44 becomes a blocking port (BL) for shutting off the loop between the bridges.

The hello packet is sent out from each port of the route bridge 43 to the low-ranking bridge 44 at a predetermined period, and when the low-ranking bridge 44 receives this hello packet, it can be confirmed that no change is caused in the network structure. FIG. 6B is a view showing a case in which the route bridge 43 is blocked or removed and the low-ranking bridge 44 is changed into a route bridge by reconstructing the network by the spanning tree protocol.

FIG. 7 is a view showing an example of the spanning tree protocol executed when the network is reconstructed from FIG. 6A to FIG. 6B.

In FIG. 7, the hello packet is sent at the hello interval (hello-time shown in FIG. 3) from the route bridge 43 in the forwarding state to the low-ranking bridge 44 in the transmission permitting state (forwarding state).

In this case, when the route bridge 43 is blocked or removed as shown in FIG. 6B and the receiving interval of the hello packet by the low-ranking bridge 44 passes through the maximum age (max age-time), the low-ranking bridge 44 judges that the network structure has been changed. Therefore, it transits to the transmission stopping state (blocking state), and then it transits to the sending and receiving stopping state (listening state) and the network information is collected. Further, in this example, via the topology learning state (learning state), the bridge itself is judged to be a route bridge, and all of its ports are set to be representative ports. After that, it transits to the transmission permitting state (forwarding state) and the sending of the hello packet is started.

FIGS. 8A, 8B and 9 show another example of restoration from the bridge faults and reconstruction of the network by installing more bridges.

FIG. 8A is a view showing a state before restoration of the bridge or installation of more bridges. FIG. 8B is a view showing a state after restoration of the bridge or installation of more bridges. The network is the same as that shown in FIGS. 6A and 6B.

FIG. 9 is a view showing an example of the spanning tree protocol executed when the network is reconstructed from FIG. 8A to FIG. 8B.

In FIG. 9, the bridge 43 (shown in FIG. 8B), which is newly added to the network for restoration from a blockade or for installing more bridges, sends a configuration BPDU message to the network on the assumption that the bridge itself is a route bridge.

Due to the foregoing, the route bridge 44 judges that the network structure is changed and transits to the sending and receiving stopping state (listening state) via the transmission stopping state (blocking state), and network information is collected. In this example, via the topology learning state (learning state), the bridge 43 becomes a route bridge, and the bridge 44 becomes a low-ranking bridge. After that, both bridges transit to the transmission permitting state (forwarding state), and the new route bridge 43 starts sending the hello packet.

As can be seen in the above two examples, in both cases, communication between the networks is stopped in the time of delay timer (bridge-delay timer)×2. As described above, in the case where the network is composed of an apparatus on which the spanning tree protocol stipulated by IEEE802.1D is installed, when the network structure is changed, for example, when the network is extended by installing more bridges in the network, or when the network device such as a bridge which has already been installed is moved, or when the bridge composing the network is failed, or when restoration from the fault is made, the topology change motion is necessarily made by the spanning tree protocol. Therefore, correspondence between the network is stopped for a predetermined period of time.

### SUMMARY OF THE INVENTION

The present invention has been accomplished to solve the above problems. It is an object of the present invention to provide a spanning tree control unit and method thereof in which the tree structure (topology) of a network is not changed in the case of installation of more devices in the network and also in the case of restoration from a fault. Due to the foregoing, it is possible to prevent communications in the entire network from stopping for a predetermined period of time in case of installation of more devices in the network and also in the case of restoration from a fault.

It is another object of the present invention to provide a spanning tree control unit and method thereof in which only user data can be transmitted without changing the present network topology in the case of installing more devices in the network and also in the case of restoration from a fault. Due to the foregoing, it becomes possible to continue the present network motion without stopping communications in the entire network in a predetermined period of time by reconfiguration of the network.

The present invention provides a spanning tree control unit comprising: means for making a device transit to a state in which only receiving is conducted in the case of installation of more devices in the network by the spanning protocol or in the case of restoration of motion in the network; means for calculating the priority of an own device by which the existing network is not changed by information in the network collected in the state in which only receiving is conducted; and means for making the device transit to a state in which sending and receiving can be conducted after the calculated priority has been set in the own device.

Also, the present invention provides a spanning tree control unit comprising: means for making a device transit to a state in which only receiving is conducted in the case of installation of more devices for connecting the network by a plurality of spanning tree protocols or in the case of restarting motions of the devices; means for grouping networks by the route discrimination information of the networks in the information in the plurality of networks collected in the state in which only receiving is conducted; means for calculating the priority of an own device to satisfy all priorities by which the existing network topology of the grouped networks is not changed; and means for making the device transit to a state in which sending and receiving can be conducted after the calculated priority has been set in the device.

The above spanning tree control unit further comprises means for prohibiting a spanning tree protocol control message across the networks from being transmitted but for allowing transmission of user data except for that.

### BRIEF DESCRIPTION OF THE DRAWINGS

The present invention will be more clearly understood from the description as set forth below with reference to the accompanying drawings.

FIG. 1 is a view showing an example of a physical network constructed by a spanning tree protocol.

FIG. 2 is a view showing a logical network of FIG. 1.

FIG. 3 is a view showing a BPDU message format.

FIG. 4 is a state transition diagram of a spanning tree.

FIG. 5 is a view showing an example of a network constructed by a spanning tree protocol.

FIG. 6A is a view showing an example (1) before a network reconstruction conducted due to the occurrence of a bridge fault or the removal of a bridge.

FIG. 6B is a view showing an example (2) after a network reconstruction conducted due to the occurrence of a bridge fault or the removal of a bridge.

FIG. 7 is a view showing an example of control sequence by the spanning tree protocol shown in FIGS. 6A and 6B.

FIG. 8A is a view showing an example before a network reconstruction conducted due to the restoration from of a bridge fault or due to the installation of more bridges.

FIG. 8B is a view showing an example after a network reconstruction conducted due to the restoration from of a bridge fault or due to the installation of more bridges.

FIG. 9 is a view showing an example of control sequence by the spanning tree protocol of FIGS. 8A and 8B.

FIG. 10 is a state transition diagram of a spanning tree control unit of the present invention.

FIGS. 11A and 11B are operation flow charts of FIG. 10.

FIG. 12 is a view showing an example (1) in which a spanning tree control unit of the present invention is added to a single network.

FIG. 13 is a view showing an example (2) in which a spanning tree control unit of the present invention is added to a single network.

FIG. 14 is a view showing an example (1) in which a spanning tree control unit of the present invention is added to a plurality of networks.

FIG. 15 is a view showing an example (2) in which a spanning tree control unit of the present invention is added to a plurality of networks.

FIG. 16 is a view showing an example (3) in which a spanning tree control unit of the present invention is added to a plurality of networks.

FIG. 17 is a view showing an example (1) of the structure of a spanning tree control unit of the present invention.

FIG. 18 is a view showing an example (2) of the structure of a spanning tree control unit of the present invention.

FIG. 19 is an operation flow chart of FIG. 18.

FIG. 20 is a view showing an example (3) of the structure of a spanning tree control unit of the present invention.

FIG. 21 is an operation flow chart of FIG. 20.

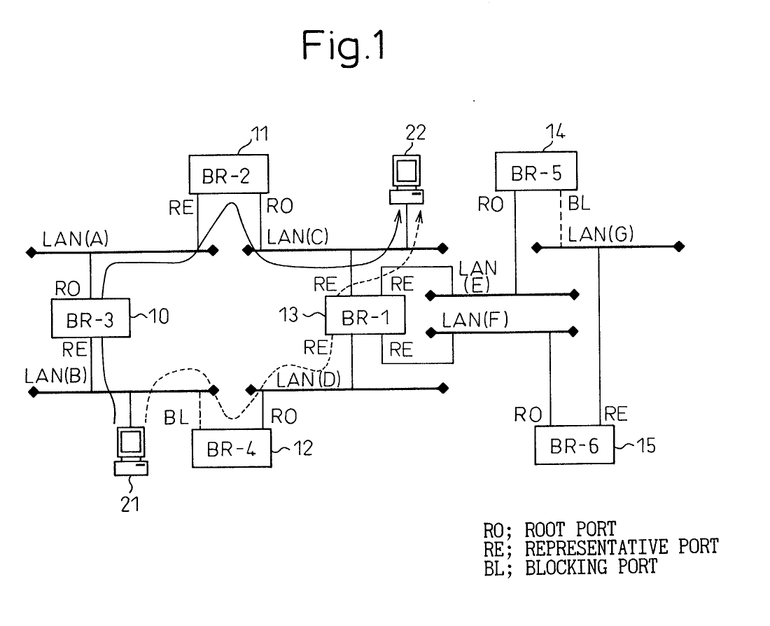

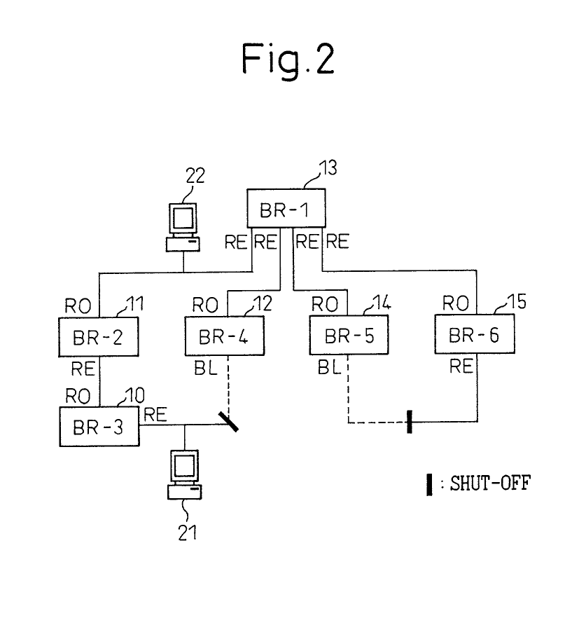

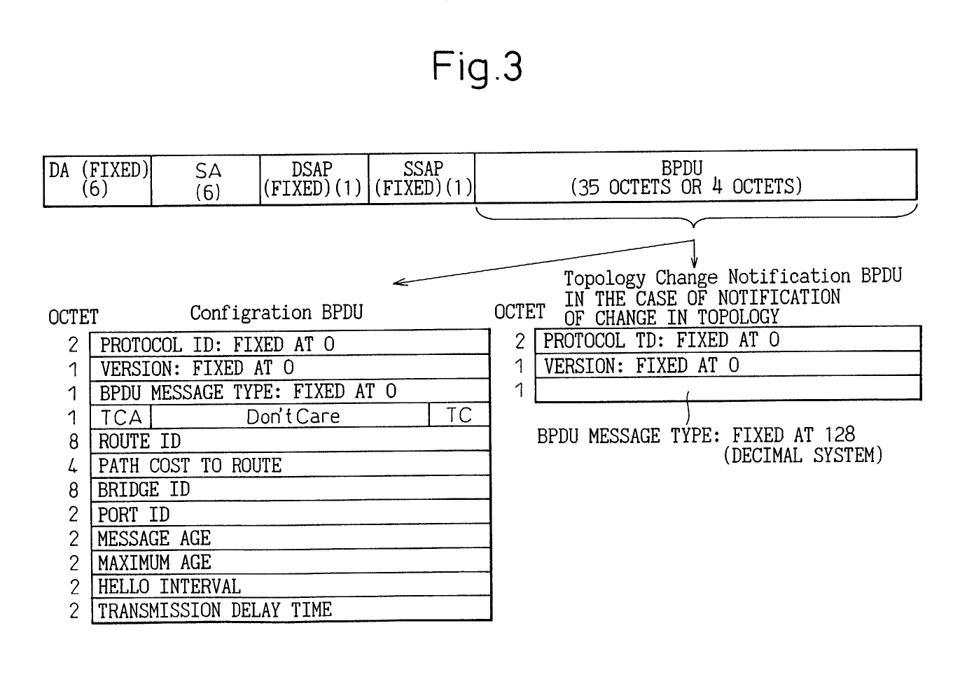

### DESCRIPTION OF THE PREFERRED EMBODIMENTS

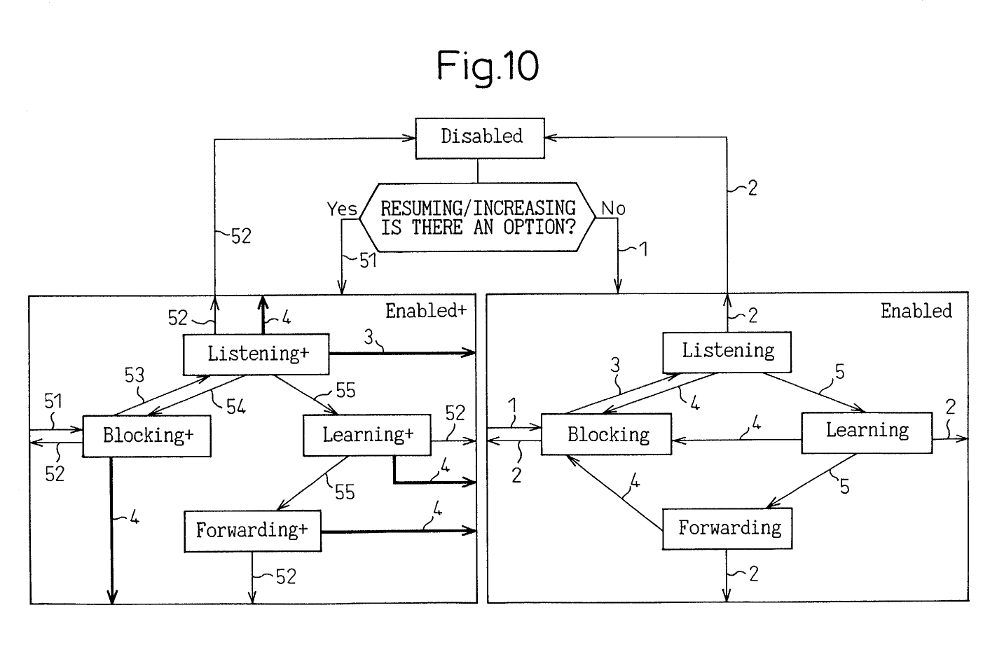

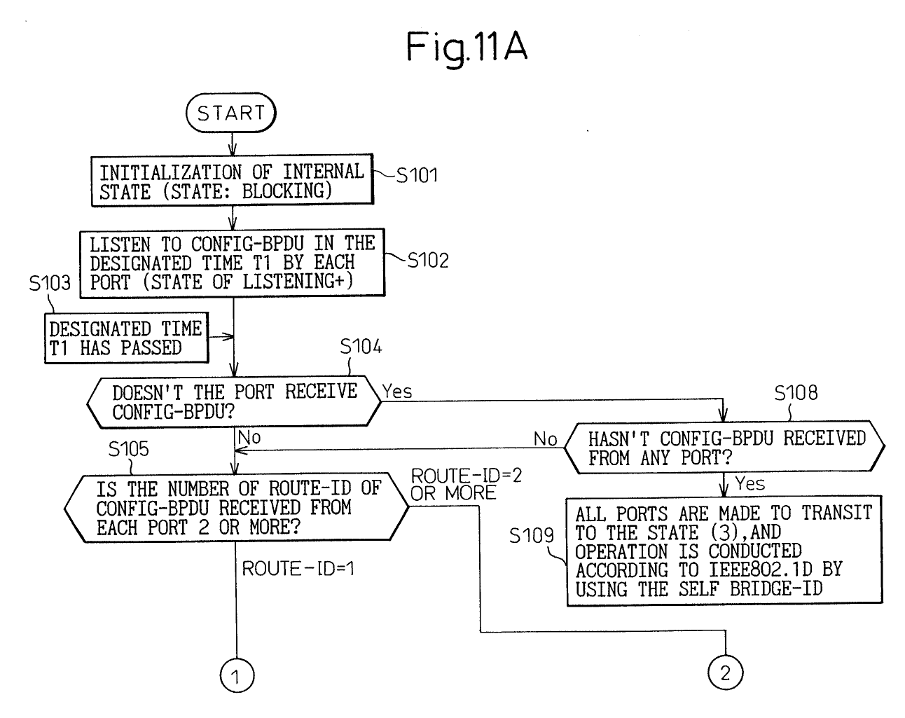

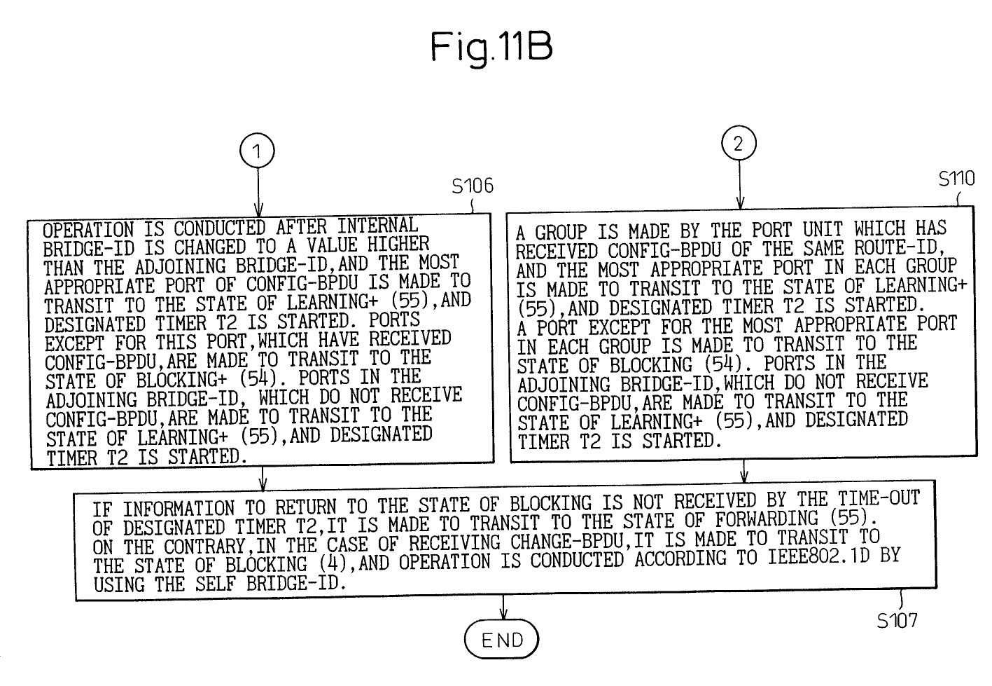

FIG. 10 is a state transition diagram of a spanning tree control unit of the present invention. FIGS. 11A and 11B are operation flow charts of FIG. 10.

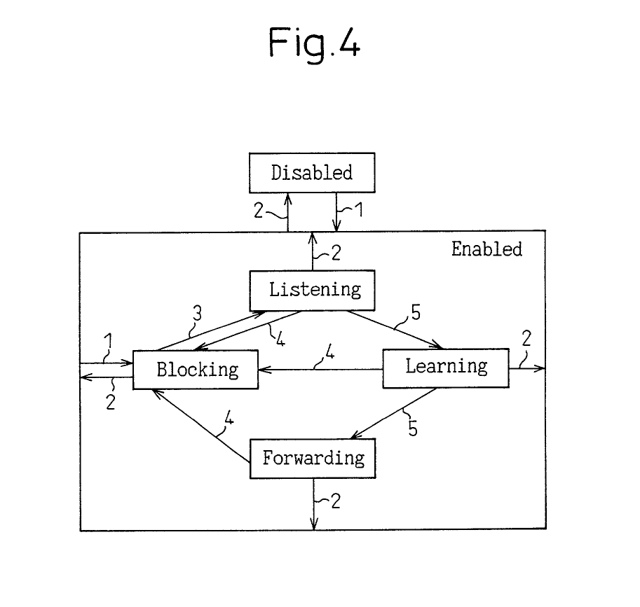

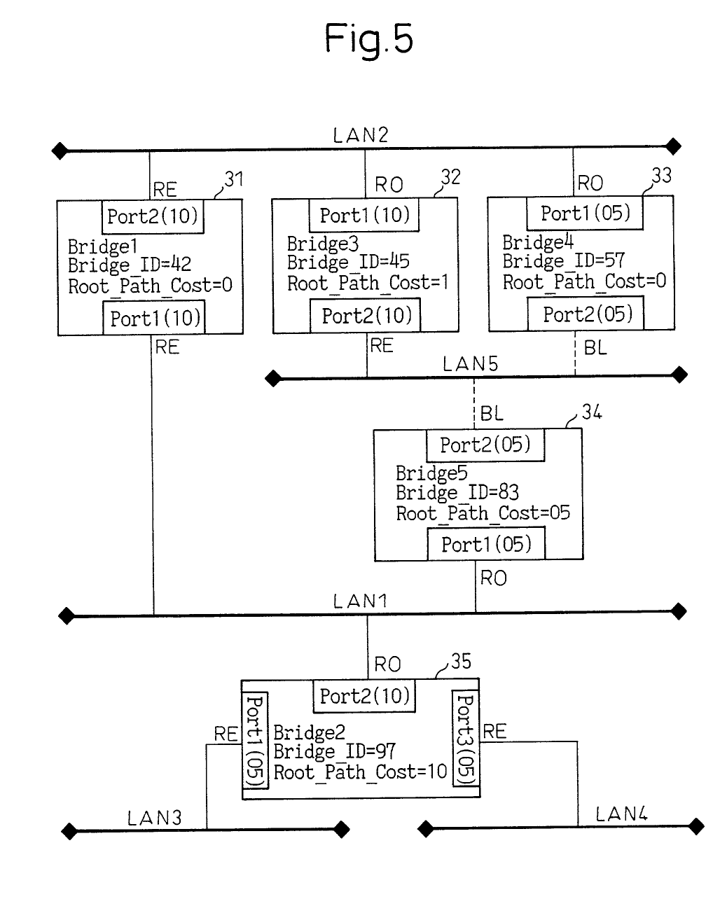

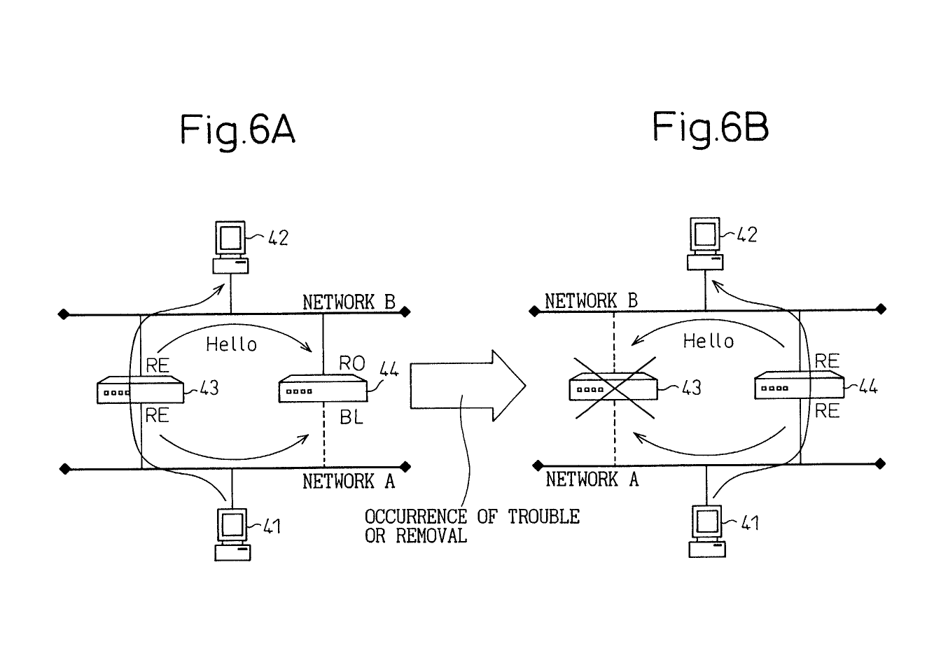

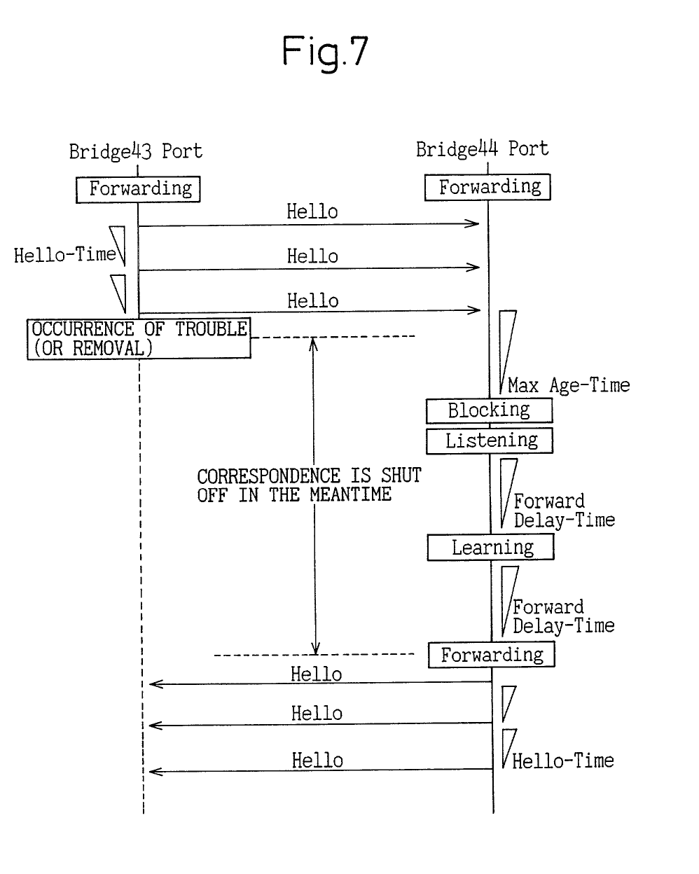

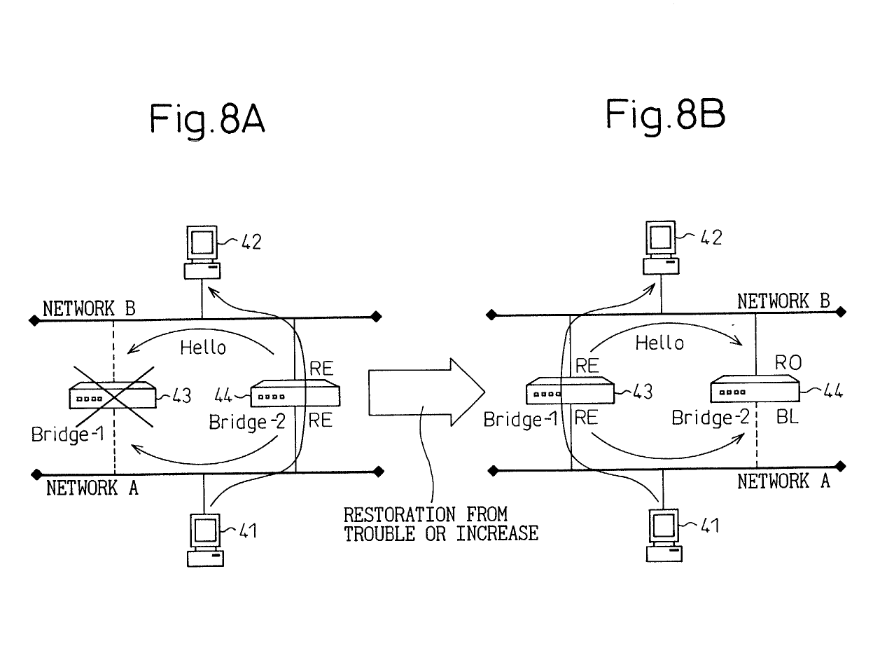

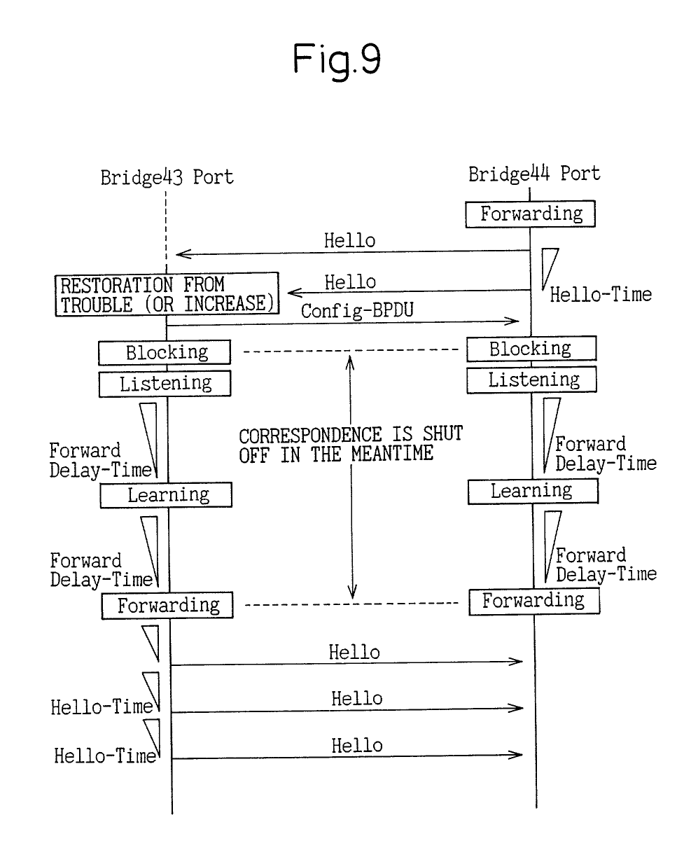

In FIG. 10, when a device having a function of the present invention is added to a network by the restoration or installation of more devices, the state transits from a stopping state (disabled state) in which the spanning tree protocol does not act due to the initialization of bridge management to an enabled state (Enabled+) in which a port of the present invention can be used (51). In this connection, in the case except for a case of the restoration in which a new device is not added to the network or in the case except for the installation of more devices, the state transits to an operation possible state (enabled state) in which the spanning tree protocol can operate in the same manner as the conventional manner (1). This conventional enabled state will not further explained. Concerning this conventional enabled state, refer to the explanation in FIG. 4.

In the enabled state of the present invention, when each port is activated by the initialization, the state transits from the transmission stopping state (blocking state+) to the sending and receiving stopping state (listening state+) (53). In this case, in a predetermined period of time (T1), only a BPDU message is received from each port, and no message is sent from the own device. In this connection, the aforementioned predetermined period of time (T1) can be designated by a user (S101 to S103).

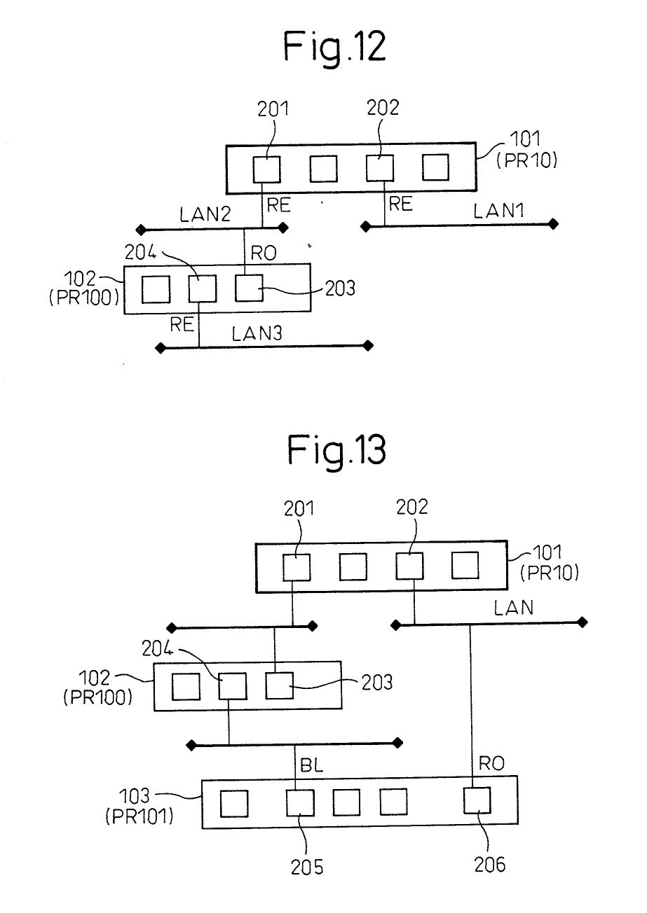

When a configuration BPDU message, in which the same one route ID is set, is received from a plurality of ports under the above condition, the own device recognizes that it is a device in a single network. This will be specifically shown in FIGS. 12 and 13. Due to the foregoing, a value higher than all bridge ID (bridgeID) in the received BPDU message is set at bridge ID of the own device, and a port which has received a BPDU message, the priority of which is highest (bridge ID is smallest) compared with all received BPDU messages, is set at a route port (RO).

After that, the state transits to the topology learning state (learning state+) (55), however, the residual ports are returned to the transmission stopping state (blocking state+) as a blocking port (BL) (9). Since the BPDU message is not sent in the transmission stopping state, states of the adjoining devices connected with these ports are not changed (S104 to S106).

On the other hand, in the case where a BPDU message having a bridge ID larger than the bridge ID of the own device is not received from any port, that is, in the case where the inner bridge ID of the own device is the largest from the first, even if the own device is added to the existing network, the topology is not changed. Therefore, the state transits to the conventional sending and receiving stopping state (listening state) (3), and operation is done according to the spanning tree protocol stipulated by IEEE802.1D (S104 to S109).

Each port in the topology learning state (learning state+) transits to the transmission permitting state (forwarding state+) after a predetermined period of time (T2) has passed (55). A port which does not receive a configuration BPDU message from the adjoining device also transits to the transmission permitting state (forwarding state+) as a representative port (55). In this connection, in the case where the aforementioned port receives a topology change notifying BPDU message, in order to comply with the topology change on the network side, the state transits to the conventional transmission stopping state (blocking state) (4). After that, operation is done according to the spanning tree protocol stipulated by IEEE802.1D (S107).

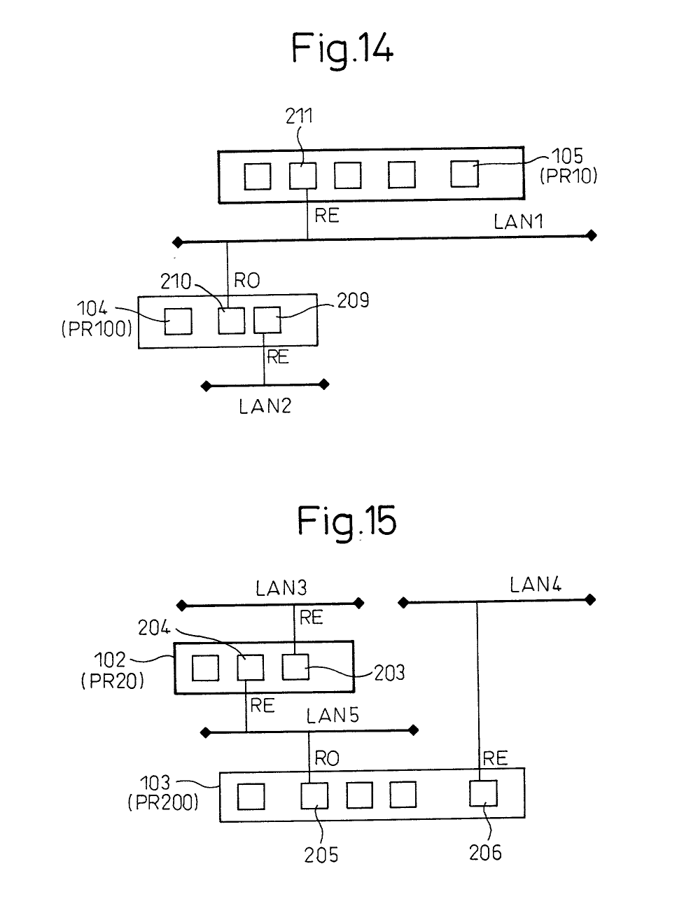

When configuration BPDU messages, in which different IDs are set, are received from a plurality of ports, it is recognized that the own device is set at a position to connect a plurality of networks. This will be specifically explained in FIGS. 14 to 16 later. In this case, the ports are grouped for each ID in the received BPDU message, and a value higher than the bridge ID received by each group is set at the bridge ID of the own device.

After that, a port which has received a BPDU message, the priority of which is highest (the bridge ID of which is lowest) in the received bridge IDs in each group, is made to transit to the topology learning state (learning state+) after a predetermined period of time (T1) has passed (55). In order to prevent the occurrence of a loop, the residual ports are made to transit to the transmission stopping state (blocking state+) as a blocking port (BL) (54). Each port in the topology learning state (learning state+) transits to the transmission permitting state (forwarding state+) as a route port (RO) in the respective network after a predetermined period of time (T2) has passed (55) (S105 and S110).

In this transmission permitting state (forwarding state+), the user data in the own group and the BPDU message can be transmitted. However, only the user data can be transmitted into the own group, and the BPDU message received from other groups is not transmitted so as to prevent a topology change generated in other networks from having influence on the own network. As a result, communication can be made between a plurality of groups without changing the topology.

FIGS. 12 and 13 are views showing an example in which a spanning tree control unit of the present invention is added to a single network having one route.

In FIG. 12, LAN 1, 2, 3 are respectively connected with each other by the devices 101, 102. In this case, the ports 201, 202 of the device 101 and the ports 203, 204 of the device 102 are in the transmission permitting state (forwarding state), and the priority (bridge-ID) of the device 101 is set at “10” and the priority (bridge-ID) of the device 102 is set at “100”. Accordingly, the route bridge is the device 101 as shown by a bold line which is the same in the following views.

Next, the device 103 of the present invention is connected to the network shown in FIG. 13. In this case, when the device is added, the ports 205, 206 of the device 103 transmit to the sending and receiving stopping state (listening state+) (51 and 53). The priority of the route ID of the configuration BPDU message received by the port 205 is “10”, and the priority of the bridge ID is “100”. The priority of the route ID of the configuration BPDU message received by the port 206 is “10”, and the priority of the bridge ID is “10”.

The device 103 compares the route ID of the configuration BPDU message received from the port 205 with the route ID of the configuration BPDU message received from the port 206. When it is confirmed that they coincide with each other, it is judged that the own device belongs to a single spanning tree protocol entity. As a result, the priority which has been previously set in the own device is set at “101” which is the lowest value (the highest value as the bridge ID).

Next, the bridge ID received from the port 205 is compared with the bridge ID received from the port 206, and the port 205 receiving the bridge ID, the value of which is the highest, is made to transmit to the transmission stopping state (blocking state+) so as to prevent the generation of a loop. On the other hand, the port 206 transmits to the topology learning state (learning state+) after a predetermined period of time (T1) has passed, and further the port 206 transmits to the transmission permitting state (forwarding state+) after a predetermined period of time (T2) has passed. As described above, the device 103 of the present invention can be added to the network without stopping the communication between the devices 101 and 102, that is, without changing the existing topology of the networks.

In this connection, in order to return the network, which is in the above stable condition, to a composition intended by a network designer, for example, the ports 205, 206 of the device 103 in the transmission permitting state (forwarding state+) are made to transit to the conventional transmission stopping state (blocking state) at midnight at which the traffic is not congested, and further the bridge ID of the own device is changed to a previously set value, so that the configuration BPDU message is sent to all ports.

Due to the foregoing, all ports of the devices 101, 102 transmit to the transmission stopping state (blocking state), and the route bridge deciding process according to IEEE802.1D is started. This operation is started, for example, when a network manager issues a previously prepared command.

In the above embodiment, the port 206 of the device 103 is made to transit from the topology learning state (listening state+) to the topology learning state (learning state+), however, after the inner bridge ID has been set according to the above comparison, the port 206 of the device 103 may be made to transit to the conventional topology learning state (listening state) or alternatively the port 206 of the device 103 may be made to directly transit to the topology learning state (learning state), because the bridge ID has already been set in this case so that the existing network topology cannot be changed. Further, the present function can be realized when the configuration BPDU message is prohibited from being sent in a predetermined transition condition so that other devices cannot recognize that it is a spanning tree entity.

FIGS. 14 to 16 are views showing an embodiment in which the spanning tree control unit of the present invention is added to a plurality of networks composed of a plurality of routes.

In FIG. 14, LAN 1 and LAN 2 are connected to each other by the devices 104 and 105. At this time, the port 211 of the device 105 and the ports 209, 210 of the device 104 are in the transmission permitting state (forwarding state), and the priority of the device 105 is set at “10”, and the priority of the device 104 is set at “100”. Accordingly, the route bridge of this network is the device 105.

In FIG. 15, LANs 3, 4 and 5 are connected to each other by the devices 102 and 103. The ports 203, 204 of the device 102 and the ports 205, 206 of the device 103 are in the transmission permitting state (forwarding state), and the priority of the device 102 is set at “20” and the priority of the device 103 is set at “2001”. Accordingly, the route bridge of this network is the device 102.

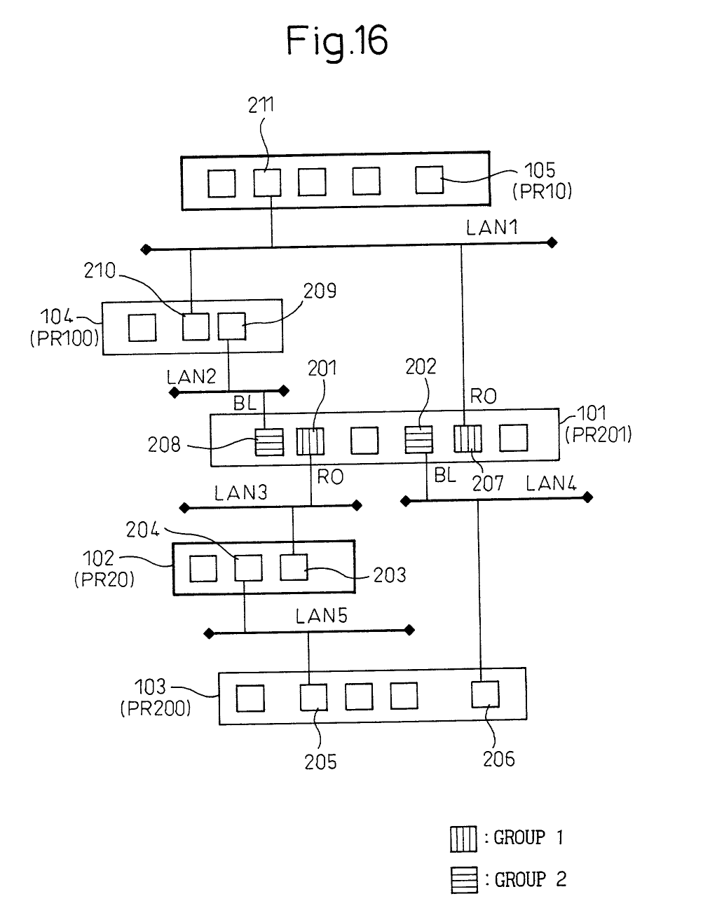

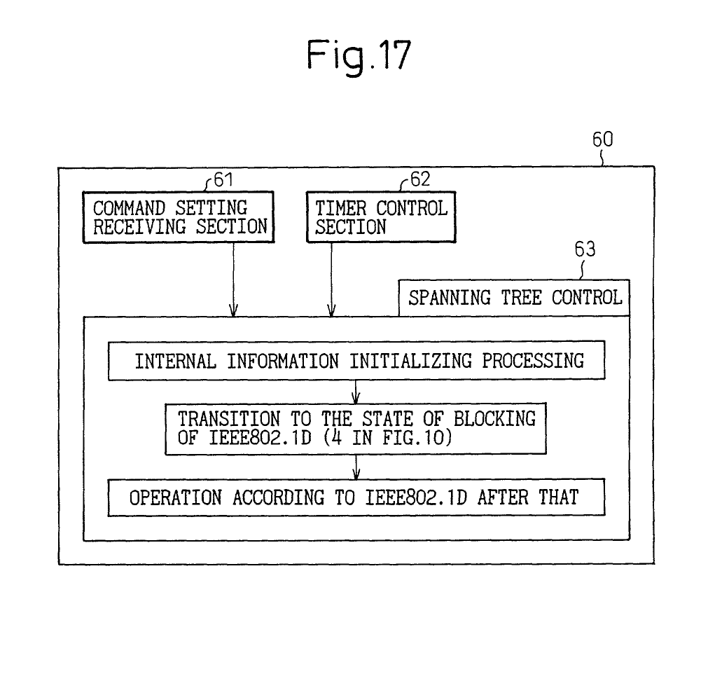

FIG. 16 is a view showing an example of the network in which FIGS. 14 and 15 are connected to each other when the spanning tree control unit 101 of the present invention is added. In this case, the ports 201, 202, 207, 208 of the device 101 transit to the sending and receiving stopping state (listening state+) (51 and 53).

In this case, with respect to the network side of FIG. 14, the priority of the route ID of the configuration BPDU message received by the port 207 is “10”, and the priority of the bridge ID is “10”, and the priority of the route ID of the configuration BPDU message received by the port 208 is “10”, and the priority of the bridge ID is “100”.

With respect to the network side of FIG. 15, the priority of the route ID of the configuration BPDU message received by the port 201 is “20”, and the priority of the bridge ID is “20”, and the priority of the route ID of the configuration BPDU message received by the port 202 is “20”, and the priority of the bridge ID is “200”.

Due to the foregoing, the device 101 compares the route ID of the configuration BPDU message received from one port with the route ID of the configuration BPDU message received from another port. When it is confirmed that they are different from each other, it is judged that the own device belongs to a plurality of spanning tree protocol entities. In this embodiment, the ports 201, 202, the priority of the route ID of which is “20”, and the ports 207, 208, the priority of the route ID of which is “10”, are respectively grouped into the groups 1 and 2, and the priority which has been previously set at the own device 101 is set at the lowest value “201” (the highest value as the bridge ID).

Next, the bridge ID received from the port 201 of the group 1 is compared with the bridge ID received from the port 202, and the port 202 which has received the bridge ID “200”, the value of which is highest, is made to transit to the transmission stopping state (blocking state+). On the other hand, the port 201 transits to the topology learning state (learning state+) after a predetermined period of time (T1) has passed. Further, the port 201 transits to the transmission permitting state (forwarding state+) after a predetermined period of time (T2) has passed.

In the same manner, the bridge ID received from the port 207 of the group 2 is compared with the bridge ID received from the port 208, and the port 208 which has received the bridge ID “100”, the value of which is highest, is made to transit to the transmission stopping state (blocking state+). On the other hand, the port 207 transits to the topology learning state (learning state+) after a predetermined period of time (T1) has passed. Further, the port 207 transits to the transmission permitting state (forwarding state+) after a predetermined period of time (T2) has passed.

As described above, in this embodiment, when the spanning tree control unit 101 of the present invention acts as the lowest-ranking device in each network, it becomes possible to construct a new network topology without stopping the communication of other devices. When user data received by the port 201 or 207, which is a port of each group in the transmission permitting state (forwarding state+), is transmitted to the port 207 or 201 which is a port of another group in the transmission permitting state (forwarding state+), it becomes possible to communicate between two or more networks via the ports 201 and 207.

In this case, the ports 201 and 207 function as a simple bridge port. However, in order to prevent a change in the topology lying across the networks, the ports 201 and 207 in the transmission permitting state (forwarding state+) do not transmit the configuration BPDU message, which has been received from one network, to the other network.

In this embodiment, in order to return the network, which is the above stable condition, to a composition intended by a network designer, for example, after the ports 201, 207 of the device 101 in the transmission permitting state (forwarding state+) are made to transit to the transmission stopping state (blocking state) at midnight, at which the traffic is not congested, and grouping is released. Next, the bridge ID of the own device is changed to a previously set value, so that the configuration BPDU message is sent to all ports.

Due to the foregoing, all ports of other devices transit to the transmission stopping state (blocking state), and a process for deciding the route bridge according to IEEE802.1D is started. As a result, two networks are unified and reconstructed to a single network according to the spanning tree protocol. This operation is started, for example, when a network manager issues a command which has been previously prepared.

In the same manner as that of the aforementioned single network, as long as the bridge ID is set in the device 101 of the present invention so that the existing network topology can not be changed, it is possible to use the same state transition as the conventional state transition. In the predetermined transition state, it is also possible to realize the present function when sending of the configuration BPDU message is prohibited so that other devices can not recognize the spanning tree entity.

FIG. 17 is a view showing an example of the structure of the spanning tree control unit 60 of the present invention.

In FIG. 17, the spanning tree control section 63 conducts control of the spanning tree protocol according to the present invention shown in FIGS. 10 and 11. The command setting receiving section 61 receives a command such as “Change to the network topology complying with IEEE802.1D.” after the installation of more devices and/or after the restoration from a trouble, that is, during operation as the network topology in the same condition as that before by the present invention. This command is given by the manual setting in which a control panel in the device is used. Also, this command is given by a remote control via the network.

The command setting receiving section 61 notifies the spanning tree control section 63 of the reception of the aforementioned command. Due to the foregoing, the spanning tree control section 61 initializes all internal information and makes the state of each port in the device transit to the transmission stopping state (blocking state) as shown in 4 of FIG. 10. After that, it becomes possible to operate according to IEEE802.1D as shown in 1 of FIG. 10.

The timer control section 62 is provided with a function of counting until a predetermined time, that is, the timer control section 62 is provided with a function of notifying the designated time in which the clock function is used. When it has reached the designated time, the timer control section 62 notifies the spanning tree control section 63 of the fact that it has reached the designated time. In this case, the spanning tree control section 60 independently executes the initialization in the spanning tree control section 63 and the transition of the ports in the device to the transmission stopping state (blocking state) as shown in 4 of FIG. 10. After that, it becomes possible to operate according to IEEE802.1D as shown in 1 of FIG. 10. As an example, it is possible to adopt the following structure. The timer control section 62 is replaced with a traffic monitoring function of the network, so that the network topology is reconstructed after the confirmation of no traffic for a predetermined period of time.

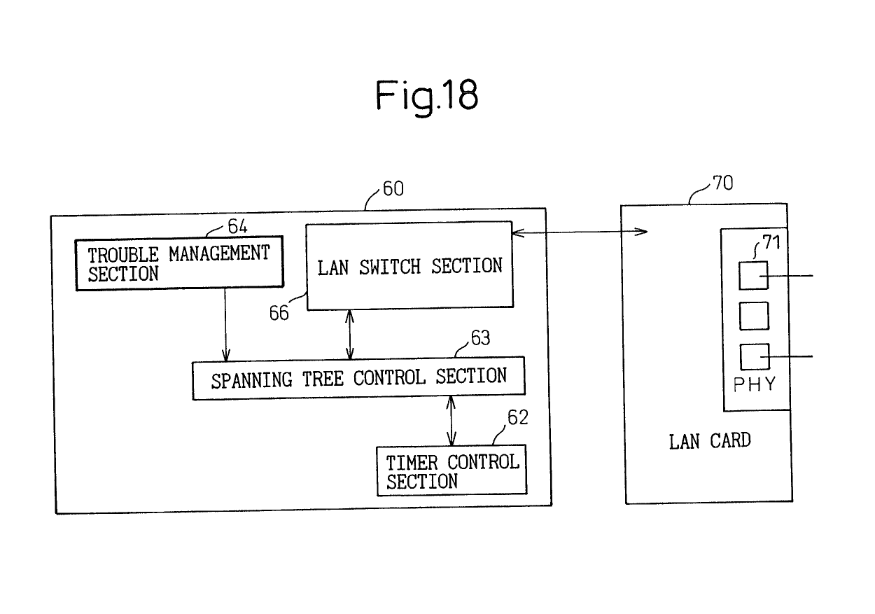

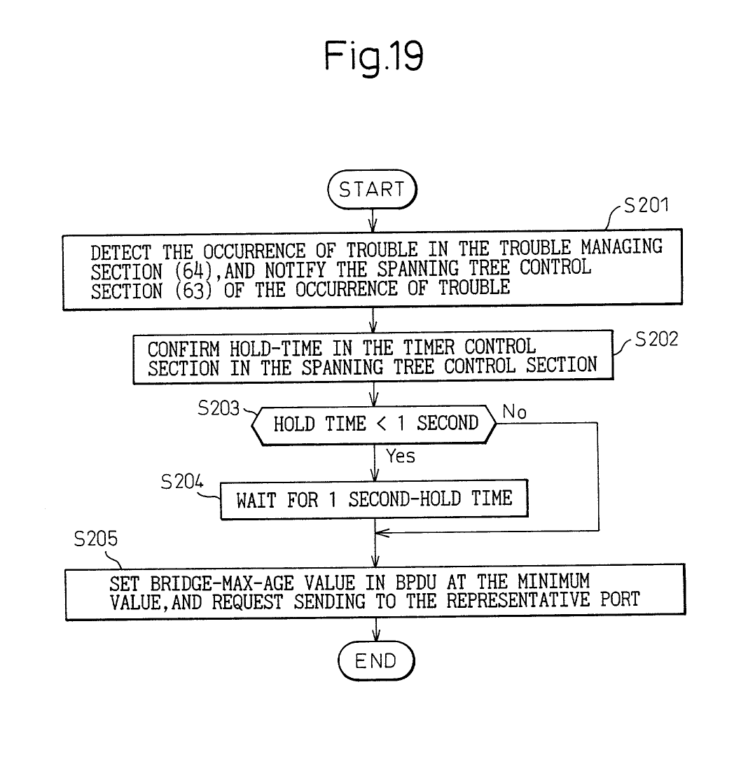

FIGS. 18 and 19 are views showing another example of the structure of the spanning tree control unit 60 of the present invention.

An object of this example is a high-ranking device such as a route bridge. When the blockade management section 64 shown in FIG. 18 judges that it is impossible to continue the present communication because of a fault of a cable, it notifies the spanning tree control section 63 of the judgment (S201).

The spanning tree control section 63 sends the BPDU message, in which the value of the message-age timer is set at 6 seconds, which is the minimum value defined by IEEE802.1D, to all ports (S202 to S205). However, in the case where the value of the hold-timer is prescribed to be 1 second in IEEE802.1D, the spanning tree control section 63 sends the BPDU message after that time has passed (S202 to S204).

This sending is executed when LAN switch section 66 controls LAN card 70 aiming at each physical port (PHY) 71. After that, the maximum age of all devices, which have received the BPDU message, is set at 6 seconds, and a fault of the own device can be detected by the adjoining device in a short period of time of 6 seconds which is the minimum value.

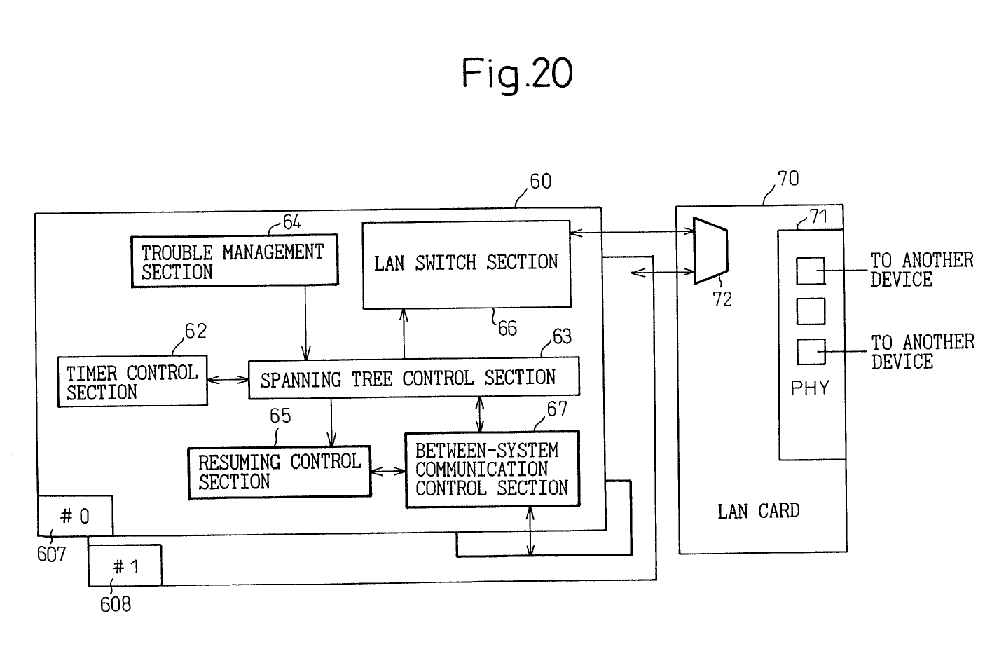

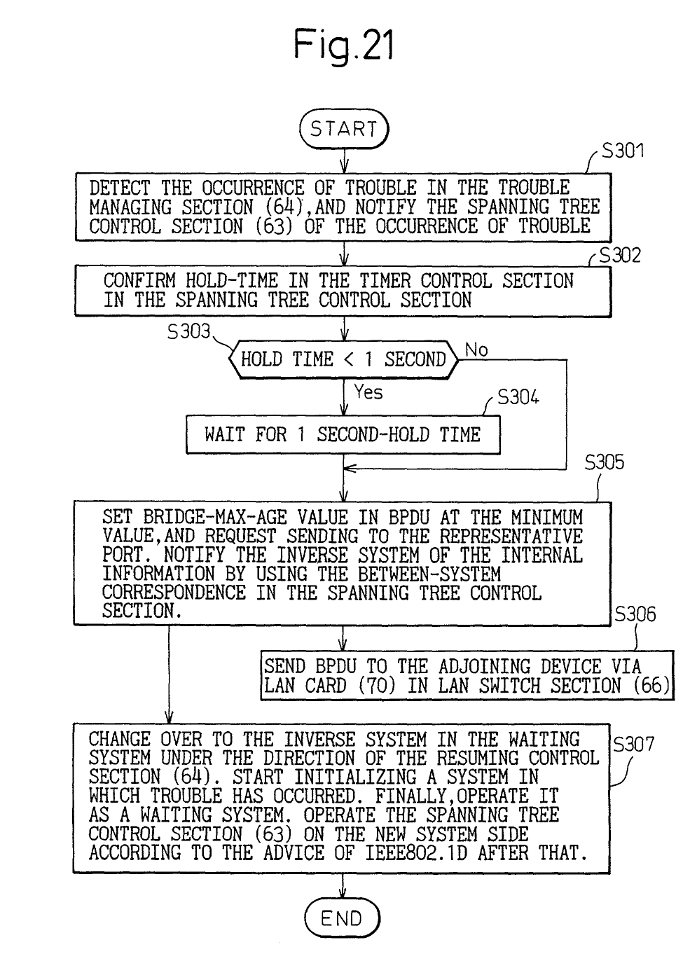

FIGS. 20 and 21 are views showing still another example of the structure of the spanning tree control unit 60 of the present invention.

In FIG. 20, the resuming control section 65, which has been newly added, conducts a resuming processing by forcibly changing over between the #0 system device 607, which is a lengthy structure in the own device, and #1 system device 608. The between-system communication control section 67 executes an information covalent function between the systems, and the selector 72 changes over between the #0 system and the #1 system on the LAN card.

As shown in FIG. 21, when a logical fault in the own device is notified from the trouble management section 64 (S301), the spanning tree control section 63 of the present invention confirms the lapse of the hold-timer value stipulated by IEEE802.1D (S302 to S304) and then sends the configuration BPDU message, in which the maximum age (bridge-max-age) is set at the maximum value (40 seconds), from each port to the adjoining low-ranking device. At the same time, the spanning tree control section 63 commands the between-system communication control section 67 that the inside information should be held in common between the systems. Further, the spanning tree control section 63 commands the resume control section 65 to change of the system (S305 and S306).

Due to the foregoing, the resuming control section 65 immediately starts the processing to change over the system. A system which is started to be newly used continues its operation by using the inner information given from the between-system communication control section 67. A system in which a fault is caused is initialized and stops its operation or continues its operation if the system is recuperated by the initialization (S307).

On the other hand, the adjoining low-ranking device, which has received the configuration BPDU message, is not supplied with the configuration BPDU message from the high-ranking device, the system of which is being changed, for the designated maximum age (40 seconds). Even if the transmission processing cannot be conducted, the adjoining low-ranking device does not start the topology change processing until the maximum age times out. Accordingly, if the high-ranking device is restored from a fault by changing the system in the meantime, no reconstruction of the network is generated by the spanning tree protocol. Therefore, correspondence can be continued as it is without temporarily stopping the entire network.

As described above, according to the present invention, concerning the device on which the spanning tree protocol is installed, in the case of installation of more devices in the network and/or in the case of occurrence of a fault and/or in the case of restoration from a fault, it is possible to operate without changing the topology by the spanning tree protocol. Therefore, even when the network is being operated, it is possible to install more devices and conduct maintenance work. Accordingly, the control unit of the present invention is excellent in practical use, and the use of a network is remarkably enhanced.

According to the present invention, it is possible to manually or automatically return the network to the tree structure, which is determined by the reliability of the device and the position of the device in the network, at a time, such as midnight, in which user data does not flow in the network. Due to the foregoing, it is possible to easily reconstruct a network in which the most reliable device is used as a route bridge.

Further, according to the present invention, when a state is detected in which it is impossible to continue communications, for example, when a fault of a device or interruption of electric power is detected, it is possible to reduce the stop time of communications in the entire network to as little as possible. When a state is detected in which communications can not be continued due to a fault caused by logical contradiction in the processing conducted in the device, communications of the entire network can be continued as it is when operation is conducted so that the adjoining device cannot detect the fault.

1. A spanning tree control unit comprising:
means for making a device transit to a state in which only receiving is conducted in the case of installation of more devices in the network by the spanning protocol or in the case of restoration of operation in the network;
means for calculating the priority of an own device by which the existing network is not changed by information in the network collected in the state in which only receiving is conducted; and
means for making the device transit to a state in which sending and receiving can be conducted after the calculated priority has been set in the own device.

2. A spanning tree control unit comprising:
means for making a device transit to a state in which only receiving is conducted in the case of installation of more devices for connecting the network by a plurality of spanning tree protocols or in the case of restarting operation of the devices;
means for grouping networks by the route discrimination information of the networks in the information in the plurality of networks collected in the state in which only receiving is conducted;
means for calculating the priority of an own device to satisfy all priorities by which the existing network topology of the grouped networks is not changed; and
means for making the device transit to a state in which sending and receiving can be conducted after the calculated priority has been set in the own device.

3. A spanning tree control unit, according to claim 2, further comprising means for prohibiting the transmission of a spanning tree protocol control message across the networks and allowing the transmission of user data except for the spanning tree protocol control message.

4. A spanning tree control unit according to one of claims 1 to 3, further comprising means for making a spanning tree protocol control message facilitate a change in the network topology including a command to shorten the network communication impossibility time in the case of detection of a communication fault, wherein the thus made message is sent to an adjoining device.

5. A spanning tree control unit according to one of claims 1 to 3, further comprising means for making a spanning tree protocol control message including command data to extend the fault detection timer time in the case of detecting a fault of the own device, wherein the thus made message is sent to an adjoining low-ranking device.

6. A spanning tree control unit according to one of claims 1 to 3, further comprising:
means for making a spanning tree protocol control message including command data to extend the fault detection timer time in the case of detecting a fault of the own device;
a plurality of active systems; and
means for changing over to a normal active system in the own device in the extended fault detection timer time.

7. A spanning tree control unit according to one of claims 1 to 3, further comprising:
receiving means for receiving a command of spanning tree protocol control conducted by IEEE802.1D sent from the outside; and
controlling means for starting spanning tree protocol control conducted by IEEE802.1D.

8. A spanning tree control unit according to one of claims 1 to 3, further comprising:
receiving means for receiving a command of spanning tree protocol control conducted by IEEE802.1D sent from the outside; and
controlling means for starting spanning tree protocol control conducted by IEEE802.1D, wherein
the command of spanning tree protocol control conducted by IEEE802.1D includes information of the designated priority, and the control means starts spanning tree protocol control conducted by IEEE802.1D after the designated priority has been set at the priority of the own device.

9. A spanning tree control method in a single network of installing more devices by the spanning tree protocol or resuming operation of the devices in the network, comprising the steps of:
making the devices transit to a state in which only receiving is conducted in the case of installing more devices or resuming the operations;
collecting information in the network in the state in which only receiving is conducted;
calculating the priority of an own device, by which the topology of the existing network is not changed, by the collected information; and
making the control unit transit to a sending and receiving possibility state after the calculated priority has been set in the own device.

10. A spanning tree control method in a plurality of networks of installing more devices for connecting the networks by a plurality of spanning tree protocol or resuming operations of the devices, comprising the steps of:
making the devices transit to a state in which only receiving is conducted in the case of installing more devices or resuming the operations;
collecting information in each network in the plurality of networks in the state in which only receiving is conducted;
grouping each network by route discriminating information of each network collected before;
calculating the priority of an own device to satisfy all the priorities by which the existing network topology of each network, which has been grouped before, is not changed; and
making the control unit transit to a sending and receiving possible state after the calculated priority has been set in the own device.
